(19) United States
(12) Patent Application Publication
(10) Pub. No.: US 2010/0057898 A1
(43) Pub. Date: Mar. 4, 2010

(54) LOAD BALANCER SETTING METHOD AND LOAD BALANCER SETTING APPARATUS

(75) Inventor: Yuji Imai, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/491,884

(22) Filed: Jun. 25, 2009

(30) Foreign Application Priority Data
Sep. 2, 2008 (JP) 2008-224866

(51) Int. Cl. G06F 15/173

(52) U.S. Cl. 709/223

(57) ABSTRACT

An administrative manager connected to servers each in which a host OS capable of loading therein a software load balancer and a guest OS executing a service program are operable as virtual OS, performs the following processes. Namely, the server in which the guest OS for executing the service program being the transmission source of a processing request to be load balanced operates is set as a setting objective server of the software load balancer. Further, the server in which the guest OS for executing the service program being the transmission target of the processing request operates is set as a load balancing objective server. Then, an instruction is transmitted to the setting objective server to load the software load balancer in the host OS thereof, and, an instruction is transmitted to the setting objective server to set information to be used for the load balancing of transmission data.

### CROSS-REFERENCE TO RELATED APPLICATION

This application is based upon and claims the benefit of priority of the prior Japanese Patent Application No. 2008-224866, filed on Sep. 2, 2008, the entire contents of which are incorporated herein by reference.

### FIELD

The embodiment discusses herein is directed to a technology for automatically setting a load balancer to a server applied with a virtualization technology.

### BACKGROUND

In recent years, demands for implementing outsourcing of information processing systems of service enterprises and the like are increased, and the market thereof is expanded. A data center collectively undertaking such outsourcing includes a server node pool configured by a plurality of servers. Then, service programs for processing customers' services of which outsourcings are consigned are discretely allocated to the plurality of servers configuring the server node pool, according to functions thereof, and also, these servers are physically network-connected.

In the server node pool described above, in order to separately administrate the services of the plurality of customers, a technology for setting a virtual machine environment in each server is generalized. To be specific, in each server, as a virtual operating system (hereunder, “operating system” is to be referred to as an OS (operating system), i.e., virtual OS, and the same rule will be applied to other operating systems), a host OS being a basis in the virtual machine environment is operated, and also, a guest OS as an environment for executing the service program is operated. Thus, even in the case where the service programs for the plurality of customers are processed on the same server, it is possible to avoid that data processed by the service programs for the customers are mixed among the customers. Further, in such a server node pool, since the physical network among the servers is shared by the plurality of customers, in order to avoid information leakage among the customers, unauthorized access and the like, a method described below is further adopted. Namely, the physical network among the servers is sectioned in L2 (Layer-2) sections using a VLAN (Virtual Local Area Network) technology or is sectioned using a VPN (Virtual Private Network) technology to thereby virtually divide the physical network, so that a virtual intranet is set up for each customer (refer to Japanese National Publication of International Patent Application No. 2004-503011).

Here, in the server node pool, it becomes necessary to perform load balancing in order to avoid concentration of processing load on a specific server. Then, in general, as a method of performing the load balancing among the servers, there has been used a method of once concentrating a processing request on a load balancer to distribute the processing request among the respective servers from the load balancer. However, in the case where the processing request is distributed as in the above, there is a problem in that traffic is concentrated in the load balancer itself to thereby cause a bottleneck. Therefore, in recent years, there has been practically applied a technology for incorporating a software load balancer into each server and distributing the processing request to thereby transmit it to the other servers, by means of a function of the software load balancer.

However, the application of such a software load balancer in the server node pool has the following problems. Namely, it is necessary to perform load balancing setting to each server into which the software load balancer is to be incorporated. However, since the servers configured the server node pool are large in number and the number of servers being objects into which the software load balancers are incorporated is obviously large, a burden required for the load balancing setting work is large. Further, in the case where a plurality of guest OS operate in one server, it is difficult to specify a guest OS in which server executes the service program which processes the processing request to be load-balanced, and also, contents of the load balancing setting are complicated. Furthermore, when the guest OS operating in each server is modified, it is necessary to modify the setting of the software load balancer corresponding to the modification of the guest OS. However, because the burden in the load balancing setting work is large, it is also difficult to flexibly correspond to the modification of server configuration.

### SUMMARY

According to an aspect of the embodiment, a computer connected to a plurality of servers each including a virtual machine environment in which a host OS capable of loading a software load balancer therein in response to an instruction and a guest OS executing a service program, are operable as virtual OS, performs following processes. Namely, a server in which the guest OS for executing a transmission source service program of a processing request being a load balancing object operates, is determined as a setting objective server of the software load balancer. Further, a server in which the guest OS for executing a transmission target service program of the processing request to be load balanced operates, is determined as a load balancing objective server. Then, an instruction is transmitted to the setting objective server to load the software load balancer into the host OS thereof. Still further, an instruction is transmitted to the software load balancer to set the load balancing objective server, as information to be used for the load balancing of transmission data from the transmission source service program.

The objects and advantages of the invention will be realized and attained by means of the elements and combinations particularly pointed out in the claims.

It is to be understood that both the foregoing general description and the following detailed description are exemplary and explanatory only and are not restrictive of the invention, as claimed.

### BRIEF DESCRIPTION OF DRAWINGS

FIG. 1 is an entire configuration view of a system providing a load balancer setting mechanism;

FIG. 2 is an explanatory view of a server configuration and a structure of data transfer between two servers;

FIG. 3A is an explanatory view of a setting table of a routing section;

FIG. 3B is an explanatory view of a setting table of a tunneling section;

FIG. 4 is a configuration view of an administrative manager;

FIG. 5 is an explanatory view of a service administration table;

FIG. 6 is an explanatory view of a load balancing information table;

FIG. 7 is a flowchart of a load balancer setting process by the administrative manager;

FIG. 8 is an explanatory view of a VPN connection, in a specific example of the load balancer setting process;

FIG. 9A is an explanatory view of the service administration table, in the specific example of the load balancer setting process;

FIG. 9B is an explanatory view of the load balancing information table, in the specific example of the load balancer setting process; and

FIG. 10 is an explanatory view of load balancing, in the specific example of the load balancer setting process.

### DESCRIPTION OF EMBODIMENT

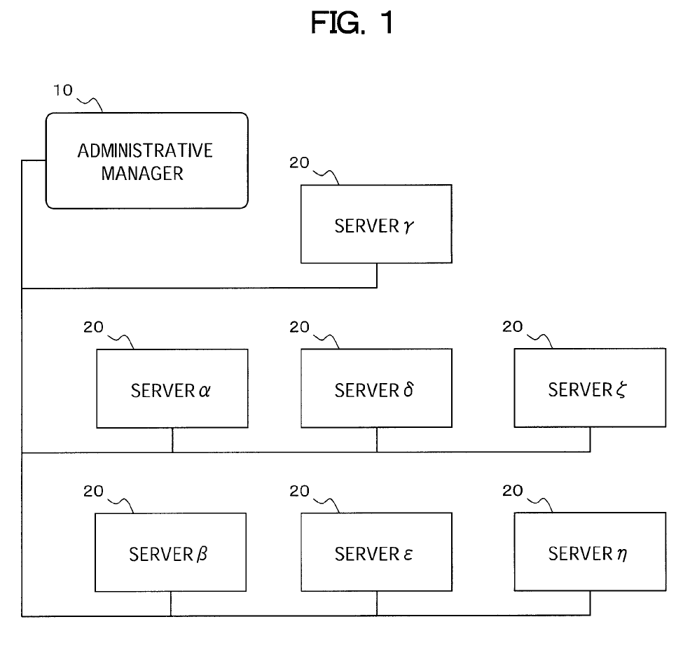

FIG. 1 illustrates an entire configuration of a system providing a load balancer setting mechanism. This system is the one set up in a server node pool installed in a data center that collectively administrates plural customers' businesses, and in this system, an administrative manager 10 and a plurality of servers 20 processing the customers' businesses are network connected. The administrative manager 10 administrates the entirety of servers 20 in lump, and also, performs various types of setting on the servers 20 by remote controls. Further, the administrative manager 10 and the servers 20 are all configured by computers each provided with at least a CPU (Central Processing Unit) and a memory.

In the plurality of servers 20 configuring the server node pool, service programs for processing the services of plural customers who consigned outsourcing to the data center are arranged. Further, each server 20 is provided with a virtual machine environment capable of operating a virtual OS. Furthermore, the servers 20 establish the VPN connection to one another in P2P (Peer to Peer) using a virtual (private) network (VPN: Virtual Private Network), and the system is divided for each customer to thereby set up a virtual intranet. Incidentally, the above virtual intranet divided for each customer is connected to own system of individual customer.

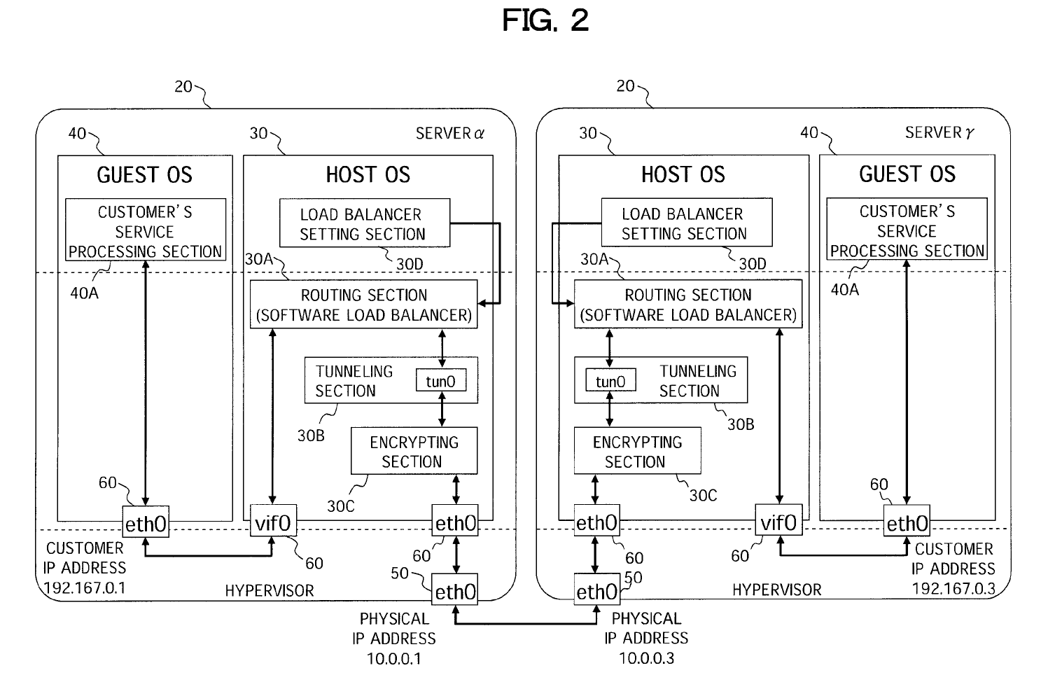

Next, referring to FIG. 2, there will be described a configuration of each server 20 provided with the virtual machine environment and a structure of the VPN connection among the servers 20.

In the server 20, the virtual machine environment is set up, and a host OS 30 and a guest OS 40 operate as virtual OS. The host OS 30 and the guest OS 40 are controlled on a hypervisor functioning as an OS control program.

Further, the server 20 is provided with a physical NIC (Network Interface Card) 50 for performing communications with other computers. Then, the server 20 is allocated with a physical IP address which is uniquely identified in the server node pool. Furthermore, each of the host OS 30 and the guest OS 40 operating in the server 20 is provided with virtual NIC 60, and communications between the host OS 30 and the guest OS 40 in the same server are performed using this virtual NIC 60. Then, the guest OS 40 operating in the server is allocated with a customer IP address as a virtual IP address which is a unique address different from the physical IP address.

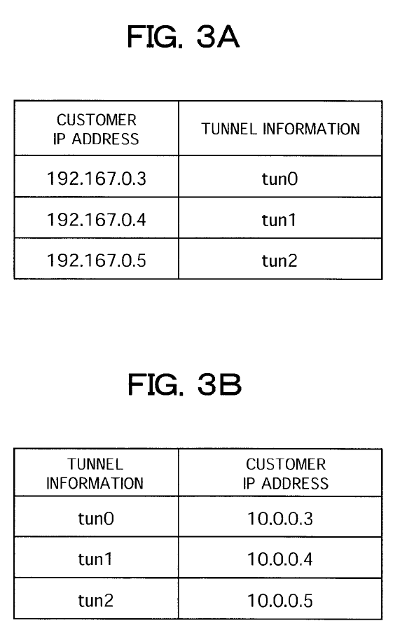

Further, the host OS 30 includes an element described below. Namely, the host OS 30 includes a routing section 30A that, when transmission data is received from the guest OS 40, specifies tunnel information for transmitting the transmission data via the VPN connection. As illustrated in FIG. 3A, the routing section 30A is provided with a routing setting table in which the customer IP addresses of the transmission targets and the tunnel information to be used for the VPN connection to the transmission target are set. Then, the routing section 30A refers to the routing setting table and specifies a tunnel to be used for VPN communications based on the customer IP address attached to the transmission data.

Furthermore, a software load balancer for load-balancing the transmission data to a plurality of transmission targets can be loaded into the routing section 30A, when the transmission data is received from the guest OS 40. This software load balancer is loaded by a load balancer setting section 30D to be described later. Incidentally, there is a LVS (Linux Virtual Server) or the like, as a specific example of means incorporated therein such a software load balancer capable of loading the software load balancer to make it to function.

Then, the software load balancer operates as follows. Firstly, when the transmission data (processing request) transmitted from the service program executed in the guest OS 40 is load-balanced to be transmitted to the plurality of servers, in place of the customer IP addresses, a representative address according to service program types determined depending on functions of the service programs to be the transmission target is attached to the transmission data. Then, the software load balancer includes load balancing information in which the representative address attached to the transmission data is associated with the customer IP addresses of the guest Oss 40 of the load balancing objective server executing the service programs of service program types corresponding to the representative address, and load balancing ratios to be transmitted to the customer IP addresses. Further, when the transmission data to be load-balanced is received from the guest OS 40, the software load balancer allocates the customer IP addresses of the guest OSs 40 in the servers to be load-balanced according to the load balancing ratios, based on the representative address attached to the transmission data, to attach the customer IP addresses to the transmission data. Then, the routing section 30A specifies the tunnels to be used for the VPN connection, based on the customer IP addresses allocated by the software load balancer as described above.

Further, the host OS 30 includes a tunneling section 30B that attaches the physical IP address of the transmission target to the transmission data and also encapsulates the transmission data to thereby perform tunneling. The tunneling section 30B is provided with a tunneling setting table in which the tunnel information and the physical IP addresses being the transmission targets of the tunnels are set, as illustrated in FIG. 3B. Then, the tunneling section 30B specifies the physical IP address of the transmission target from the tunnel information, based on the tunneling setting table.

Further, the host OS 30 comprises an encrypting section 30C that encrypts the transmission data. Furthermore, the host OS 30 includes a load balancer setting section 30D that loads the software load balancer as a part of the routing section 30A, in response to an instruction from the administrative manager 10, and also, functions as an agent which sets information necessary for performing the load balancing by mean of the software load balancer.

Incidentally, when data is received from the other server 20, in the host OS 30, the reception data is decrypted in the encrypting section 30C and encapsulation thereof is released in the tunneling section 30B, and also, in the routing section 30A, the data is transmitted to the guest OS 40 of the customer IP address attached to the reception data.

On the other hand, the guest OS 40 comprises a customer's service processing section 40A that executes the service program. Incidentally, in an example of FIG. 2, only one guest OS 40 operates, but a plurality of guest OSs 40 can operate.

Next, referring to the example of FIG. 2, there will be described a process of data transmission from the service program executed in the customer's service processing section 40A in the guest OS 40 of the server α to the service program executed in the customer's service processing section 40A provided in the guest OS 40 of the server γ. Herein, in the beginning, there will be described an example of a state where the load balancing is not performed and the software load balancer is not loaded into the routing section 30A.

Firstly, the data is transmitted from the service program executed in the customer's service processing section 40A of the server α to the customer IP address (192.167.0.3) of the guest OS 40 of the server γ, which is the transmission target. This data is transmitted to the host OS 30 via the virtual NIC 60 (eth0) of the guest OS 40 and the virtual NIC 60 (vif0) of the host OS 30. Then, in the host OS 30, the routing setting table is referred to in the routing section 30A, to thereby acquire the tunnel information corresponding to the customer IP address of the transmission target. Further, in the host OS 30, the tunneling setting table is referred to in the tunneling section 30B, to thereby acquire the physical IP address (10.0.0.3) of the transmission target server corresponding to the tunnel information. Then, this physical IP address is attached to the transmission data, and thereafter, the transmission data is encapsulated and tunneled. Further, in the encrypting section 30C, the encapsulated transmission data is further encrypted by applying IPsec or the like. As a result, it becomes possible to establish the VPN connection to the server γ. Then, the transmission data is transmitted from the virtual NIC 60 (eth0) of the host OS 30 to the server γ via the physical NIC 50 (eth0) of the server α. On the other hand, in the host OS 30 of the server γ that received the transmission data, the reception data is transmitted to the guest OS 40 being the transmission target in which the service program is executed, based on the customer IP address attached to the reception data.

By adopting the configuration described above, in the case where the data transmission and reception is performed between the own server 20 and the other server 20 in the service program, in the guest OS 40, only the customer IP address of the transmission target may be set to the transmission data, and the setting of the physical IP address and the VPN connection is performed by the host OS 30. Therefore, when the customer accesses the server to execute the service program and communicate with the other server, it becomes possible to perform such communications without the necessity of directly controlling the host OS 30. Accordingly, it becomes possible to perform the communications with the other server without providing a control authorization of the host OS 30 to the customer, and consequently, it is possible to prevent troubles, such as erroneous alteration of the environment setting of the host OS 30 by the customer.

Further, in the example of FIG. 2, there will be described a process of the routing section 30A in the case where the transmission data from the service program executed in the customer's service processing section 40A of the server α is also load-balanced to the server δ (not shown in the figure) being the other server. In this case, the software load balancer is loaded into the routing section 30A of the server α, as a part thereof. Incidentally, the description will be made on the assumption that the routing setting table is previously set so that the server α is further VPN-connected to the server δ in which the guest OS 40 allocated with the customer IP address (192.167.0.4) operates, using the tunnel (tun1).

Here, the data transmitted from the service program executed in the customer service processing section 40A of the server α is attached with the representative address (for example, (192.167.0.100)) according to the service program type of the service program being the transmission target of the transmission data, in place of the customer IP address of the specific guest OS 40. On the other hand, it is assumed that the software load balancer in the server α is set such that the data attached with the representative address (192.167.0.100) is load-balanced to the customer IP address (192.167.0.3) of the guest OS 40 operating in the server γ at a rate of 60% and the customer IP address (192.167.0.4) of the guest OS 40 operating in the server δ at a rate of 40%. Then, when in the software load balancer in the server α, the customer IP address (192.167.0.3) of the guest OS 40 operating in the server γ is determined as the allocation target of the transmission data, so that in the server α, as described in the above, the tunnel information (tun0) corresponding to the customer IP address of the transmission target is acquired from the routing setting table and the data is transmitted to the server γ. On the other hand, when in the software load balancer in the server α, the customer IP address (192.167.0.4) of the guest OS operating in the server δ is determined as the allocation target of the transmission data, the tunnel (tun1) corresponding to the customer IP address (192.167.0.4) set in the routing setting table is acquired and the data is transmitted to the server δ.

Next, there will be described the administrative manager 10 that administrates the entirety of servers 20.

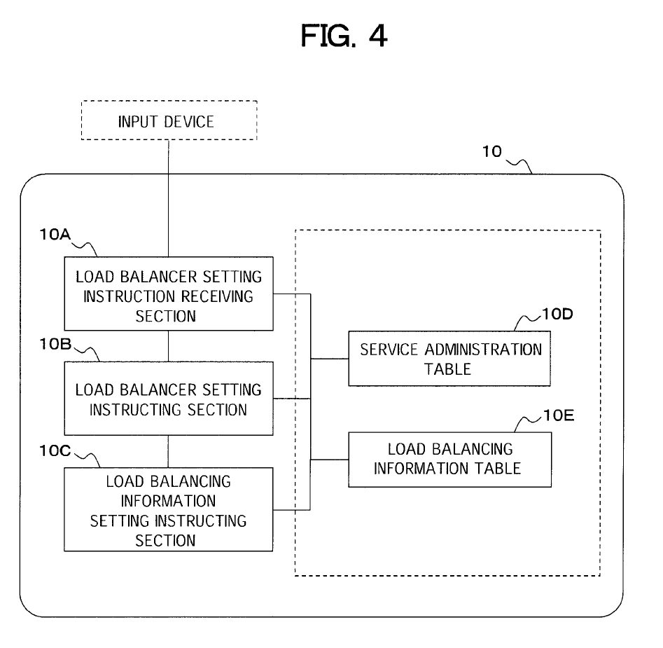

FIG. 4 is a configuration view of the administrative manager 10. The administrative manager 10 includes, a load balancer setting instruction receiving section 10A, a load balancer setting instructing section 10B, a load balancing information setting instructing section 10C, a service administration table 10D and a load balancing information table 10E.

The load balancer setting instruction receiving section 10A is connected to an input device which can be operated by an operator. Then, the load balancer setting instruction receiving section 10A receives a load balancer setting instruction in which at least the service program type of the service program being the transmission source of the transmission data (processing request) to be load-balanced is designated.

The load balancer setting instructing section 10B determines the servers to which the software load balancers are to be set, and transmits an instruction to the load balancer setting section 30D in each of the determined servers to load the software load balancer, as a part of the routing section 30A. Incidentally, the load balancer setting instructing section 10B functions as a deciding step, deciding means, a first instruction transmitting step and first instruction transmitting means.

The load balancing information setting instructing section 10C determines the servers being the load balancing objects and the load balancing ratios, and then, transmits an instruction to the software load balancer setting section 30D in each of the software load balancer setting objective servers to set the load balancing objective server and the load balancing ratio. Incidentally, the load balancing information setting instructing section 10C functions as a determining step, determining means, a second instruction transmitting step and second instruction transmitting means.

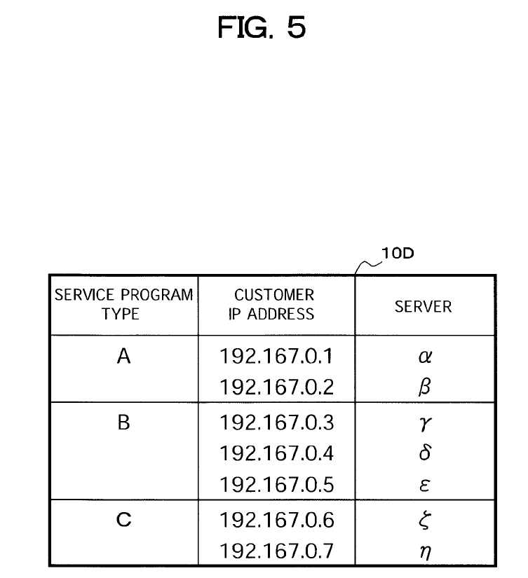

The service administration table 10D indicates, for each of service program types, the servers each in which the guest OS 40 for executing the service program of each service program type operates. As illustrated in FIG. 5, the service administration table 10D is registered with the service program types, the customer IP addresses of the guest OSs 40 executing the service programs of service program types, and the server names in which the guest OSs 40 operate.

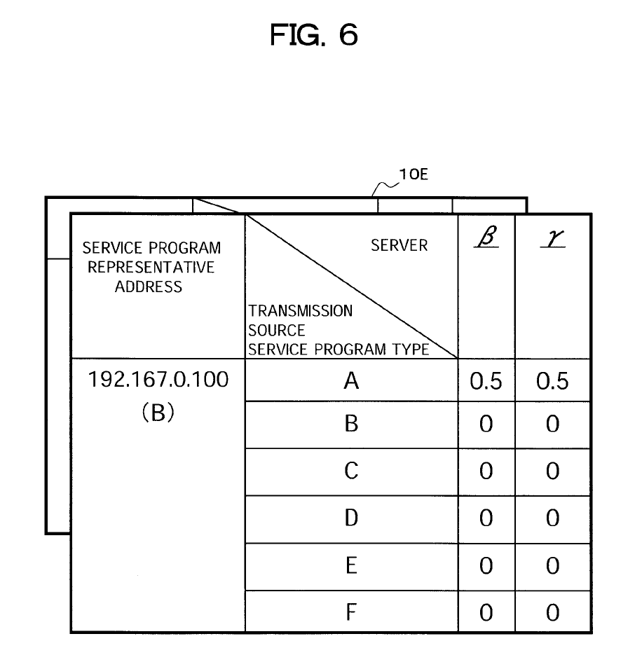

The load balancing information table 10E is configured with a set of sheets, in which, for each service program type of the service program being the transmission target of the processing request to be load-balanced, the load balancing objective servers and the load balancing ratios are set. As illustrated in FIG. 6, each sheet is registered with the servers to be load balanced and the load balancing ratios thereto, among the servers in which the guest OSs 40 for executing the service programs in the service program types operates, so as to correspond to the representative address of the service program types, according to the service program type of the service program being the transmission source of the processing request.

Incidentally, the administrative manager 10 includes such as a table for administrating the physical IP address of each server, in addition to the above components, in order to administrate in lump the entirety of the servers 20 and also to perform various settings to each server.

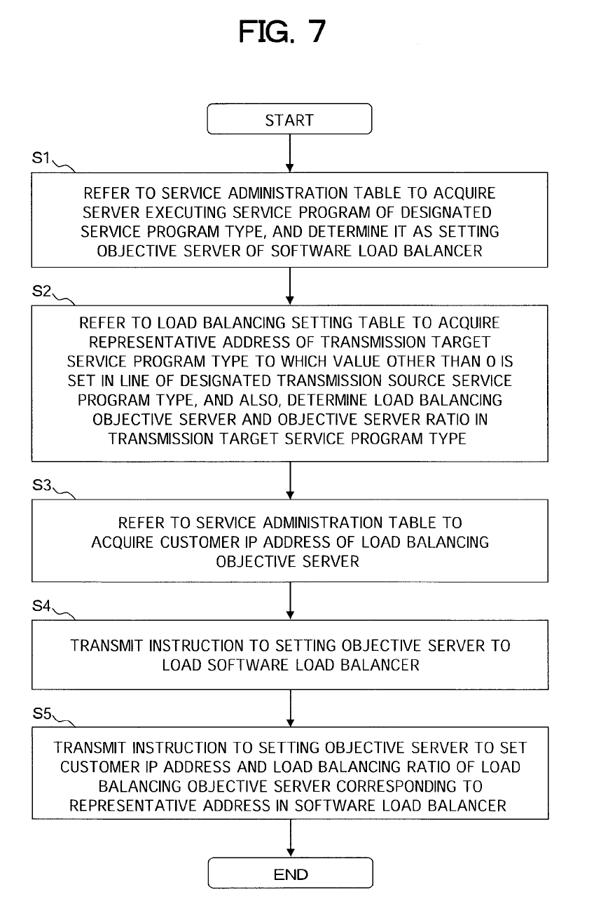

FIG. 7 illustrates a load balancer setting process by the load balancer setting instructing section 10B and load balancing information setting instructing section 10C of the administrative manager 10. This process is executed when the load balancer setting instruction in which at least the service program type of the service program being the transmission source of the processing request to be load balanced is designated, is received in the load balancer setting instruction receiving section 10A.

In step 1 (to be abbreviated as S1 in the figure, and the same rule will be applied to subsequent steps), referring to the service administration table 10D, the servers each executing the service program of the designated service program type are acquired. Then, the acquired servers are determined as the setting objective servers in which the software load balancers are to be loaded into the hosts OS 30 thereof.

In step 2, referring to the load balancing information table 10E, the representative address of the service program types each set with a value other than 0 in a line in which the designated service program type is the transmission source, is acquired as the representative address of the transmission target service program types. Further, from each sheet of the transmission target service program types, the load balancing objective servers in which the designated service program types are the transmission sources, and the load balancing ratios thereto, are acquired to be determined as the load balancing objective servers and the load balancing ratios.

In step 3, referring to the service administration table 10D, and the customer IP addresses of all of the load balancing objective servers are acquired.

In step 4, the instruction is transmitted to each of the load balancer setting section 30D of the host OS 30 in the setting objective server to load the software load balancer. Incidentally, the load balancer setting section 30D in the setting objective server loads the software load balancer as a part of the routing section 30A in response to the instruction.

In step 5, the instruction is transmitted to the load balancer setting section 30D of the host OS 30 in the setting objective server, to set the load balancing objective servers determined in step 2 and the load balancing ratios to the load balancing objective servers, for each transmission target service program type. To be specific, the instruction is transmitted the load balancer setting section 30D to set, in the software load balancer information in which the representative addresses of the transmission target service program types are associated with the customer IP addresses of the load balancing objective servers and the load balancing ratios thereto. Incidentally, in the load balancer setting section 30D in the setting objective server, in response to the above instruction, the above information is set to the software load balancer loaded as a part of the routing section 30A.

Further, the step 2 and step 3 for determining (acquiring) the load balancing information to be set in the software load balancer and the step 4 for transmitting the instruction to the setting objective server to load the software load balancer, may be executed in reverse order to the above.

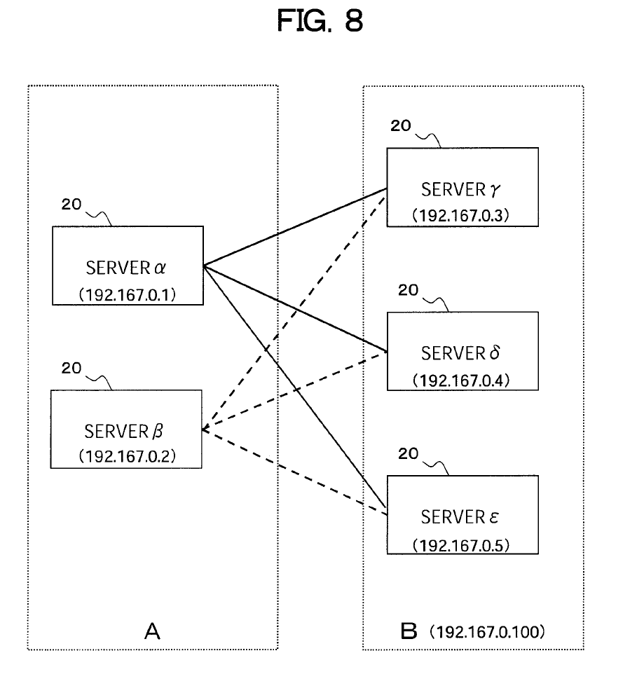

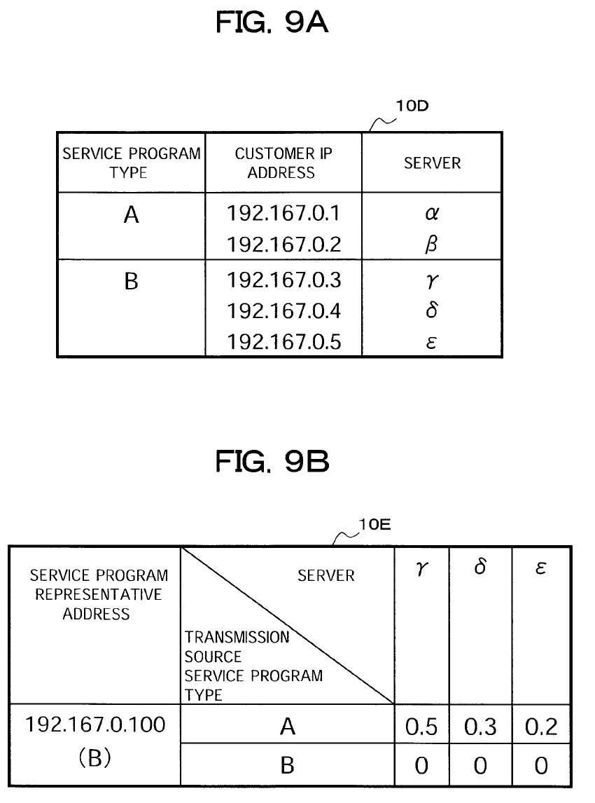

Here, there will be described as to how the load balancing is performed among the servers 20, referring to a specific example. FIG. 8 is an example of the VPN connection among the servers 20, in which the guest OSs 40 of the server α and server β execute the service program of service program type A, and the server γ, server δ and server ε execute the service program of service program type B. Incidentally, the guest Oss 40 operating in the server α, server β, server β, server δ and server ε are allocated with the customer IP addresses of (192.167.0.1), (192.167.0.2), (192.167.0.3), (192.167.0.4) and (192.167.0.5), respectively. Then, at least the VPN connection with the server α and the server β being one ends thereof is made as illustrated by solid lines and broken lines respectively. Incidentally, although not shown in FIG. 8, these servers are connected to the administrative manager 10. Then, it is assumed that data is registered in the service administration table 10D and the load balancing information table 10E of the administrative manager 10 as illustrated in FIG. 9A and FIG. 9B, respectively.

Then, the administrative manager 10 executes the following processes, when the instruction to load-balance the processing request from the service program of service program type A is received in the load balancer setting instruction receiving section 10A. Namely, the load balancer setting instructing section 10B refers to the service administration table 10D in FIG. 9A, to determine the server α and server β in each of which the guest OS 40 for executing the service program of service program type A operates, as the setting objective servers of the software load balancer (step 1). Further, the load balancing information setting instructing section 10C refers to the load balancing information table 10E in FIG. 9B, and specifies the sheet in which the value other than 0 is set in the line in which the service program of service program type A is the transmission source, to thereby acquire the representative address of the service program type in the sheet. Incidentally, in the example of FIG. 9B, only the sheet of the representative address (192.167.0.100) of the service program type B is set, and in this sheet, the value other than 0 is set in the line in which the service program of service program type A is the transmission source. Therefore, the load balancing information setting instructing section 10C acquires the representative address (192.167.0.100) of the service program type B. Further, the load balancing information setting instructing section 10C acquires the server γ, the server δ, and the server ε each of which the service program of service program type A is the transmission source, and the load balancing ratios 0.5 (50 percents), 0.3 (30 percents) and 0.2 (20 percents) of respective servers, which are set in the sheet of the representative address of the service program type B, to determine them as the load balancing objective servers and the load balancing ratios (step 2). Furthermore, the load balancer setting instructing section 10B acquires the respective customer IP addresses (192.167.0.3), (192.167.0.4) and (192.167.0.5) of the guest OSs 40 in the server γ, the server δ, and the server ε, from the service administration table 10D in FIG. 9A (step 3)

Then, the load balancer setting instructing section 10B transmits the instructions to the load balancer setting sections 30D in the server α and the server β being the software load balancer setting objective servers, to load the software load balancers (step 4). Further, the load balancing information setting instructing section 10C transmits the instruction so that the processing request to the representative address (192.167.0.100) is load balanced to (192.167.0.3) in the ratio of (0.5), (192.167.0.4) in the ratio of (0.3) and (192.167.0.5) in the ratio of (0.2) (step 5).

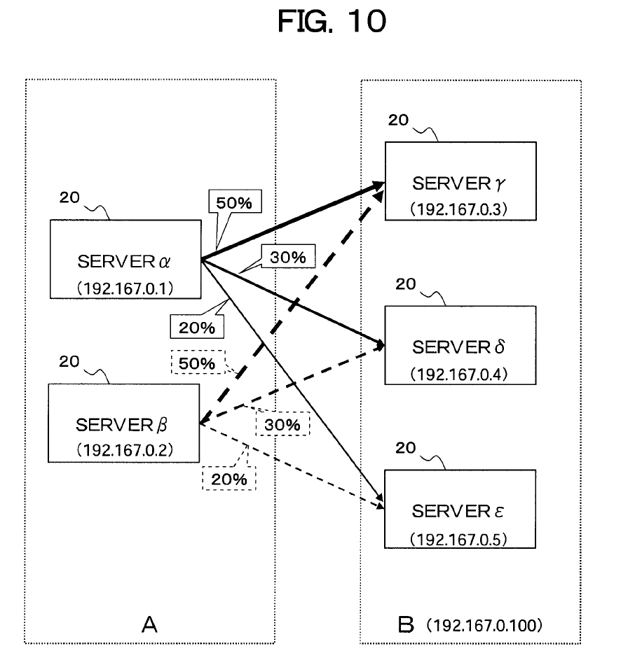

As a result, the processing requests transmitted from the server α and the server β each in which the guest OS 40 for executing the service program of service program type A operates to the service program of service program type B, are load-balanced as illustrated in FIG. 10. In FIG. 10, solid line arrows indicate the processing request from the server α and broken line arrows indicate the processing request from the server β.

According to the above-mentioned load balancer setting process, when the service program type being the transmission source of the processing request to be load-balanced is designated, the software load balancer setting objective servers are determined and the software load balancers are loaded into the host OS thereof. Then, the information necessary for the load balancing is automatically set in each of the loaded software load balancers. Therefore, in the server node pool configured by the large number of servers, even if the software load balancers are applied, the load required for the software load balancer setting work is significantly reduced, and also, it is possible to flexibly cope with the modification or the like of server configuration.

Incidentally, in the embodiment described above, both of the load balancing objective servers and the load balancing ratios are previously set in the load balancing information table 10E, and both of the load balancing objective servers and the load balancing ratios are previously set in the software load balancer. Thus, in the case where there is a difference in processing power among the load balancing objective servers, it is possible to set the load balancing ratios according to the processing powers of the load balancing objective servers. However, when the processing powers of the respective load balancing objective servers are same, only the load balancing objective servers may be previously set in the load balancing information table 10E and only the load balancing objective servers may be previously set in the software load balancer. Incidentally, in this case, the load balancing may be performed evenly on the load balancing objective servers by the software load balancer. Thus, it is possible to provide the load balancing without setting the load balancing ratios in the load balancing information table 10E.

Further, in the case where the load balancing ratios to the load balancing objective servers are previously set evenly, it is possible to automate the setting work (namely, the work of adding the load balancing information to the load balancing information table 10E). As a process thereof, firstly, when the respective service program types being the transmission source of the processing request and the transmission target thereof are designated, the servers each in which the guest OS 40 for executing the service program of service program type being the transmission target operates are specified from the service administration table 10D. Further, the sheet, in which the representative address of the service program type being the designated transmission target is set, is added to the load balancing information table 10E. Then, all of the servers specified from the service administration table 10D are set in the sheet as the servers to be load balanced, and also, the line for setting the load balancing ratios from the service program type being the designated transmission source is added. Further, the ratio of (1/(the number of the server to be load balanced)) is set to the added line, for each of the servers to be load balanced. Thus, it is possible to simplify the setting work of the load balancing information to the load balancing information table 10E.

Furthermore, the load balancer setting instruction to be received by the load balancer setting instruction receiving section 10A is not limited to that for setting the load balancer itself, and, for example, the instruction for starting the guest OS may be used as the load balancer setting instruction. To be specific, when the guest OS starting instruction is made together with the instruction of the service program to be executed by this guest OS, the above-mentioned load balancer setting process may be performed by using the service program of designated service program type as the service program being the transmission source of the processing request to be load balanced. Thus, since the setting of the software load balancer is also performed only by performing the guest OS starting instruction, it is possible to omit the work of performing again the load balancer setting instruction.

All examples and conditional language recited herein are intended for pedagogical purposes to aid the reader in understanding the invention and the concepts contributed by the inventor for furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A computer readable recording medium storing a load balancer setting program causing a computer, which is connected to a plurality of servers each including a virtual machine environment in which a host operating system that is capable of loading therein a software load balancer for distributively transmitting a processing request to a plurality of transmission targets in response to an instruction and directly performs communications with another server using a virtual network; and a guest operating system that is started up for executing a service program of processing a customer's service and performs communications with said another server only via the host operating system, are operable as virtual operating systems, to execute a process comprising:
when a load balancer setting instruction in which at least a transmission source service program for transmitting a processing request to be load-balanced is designated, is received, determining a server, in which the guest operating system for executing the transmission source service program operates, as a setting objective server of the software load balancer, and also, determining a server, in which the guest operating system for executing a transmission target service program of the processing request transmitted from the transmission source service program operates, as a load balancing objective server;
transmitting an instruction to the setting objective server to load the software load balancer into the host operating system thereof; and
transmitting an instruction to the setting objective server to set at least the load balancing objective server in the software load balancer, as information to be used for the load balancing of transmission data from the transmission source service program.

2. A computer readable recording medium storing a load balancer setting program according to claim 1,
wherein the process of determining comprises, referring to a first table, in which the servers each in which the guest operating system for executing the service program operates are set, to determine the server in which the transmission source service program is executed, as the setting objective server, and also, referring to a second table, in which the service programs being the transmission source and transmission target of the processing request are associated with each other and the servers to be load-balanced are set among the servers each in which the guest operating system for executing the service program being the transmission target operates are set, to determine the server to be load-balanced set in the second table among the servers each in which the guest operating system for executing the transmission target service program of the processing request transmitted from the transmission source service program operates, as the load balancing objective server.

3. A computer readable recording medium storing a load balancer setting program according to claim 2,
wherein a load balancing ratio is further set in the second table for each server to be load-balanced,
the process of determining comprises, further determining the load balancing ratios set in the second table, as load balancing ratios to the load balancing objective servers, and
the process of transmitting the instruction to the setting objective server to set at least the load balancing objective server in the software load balancer comprises, transmitting an instruction to the setting objective server to further set the load balancing ratios to the load balancing objective servers in the software load balancer.

4. A computer readable recording medium storing a load balancer setting program according to claim 3,
wherein each of the load balancing ratios set in the second table is set with a value according to the service program being the transmission source of the processing request, and
the process of determining comprises, determining the load balancing ratios transmitted from the transmission source service program among the load balancing ratios set in the second table, as the load balancing ratios to the load balancing objective servers.

5. A computer readable recording medium storing a load balancer setting program according to claim 3, further comprising;
when the load balancing information setting instruction to the second table, in which the respective service programs being the transmission source and transmission target of the processing request are designated, is received, setting in the second table the servers each in which the service program being the transmission target of the processing request is executed, as the servers to which the processing request from the service program being the transmission source is to be load balanced, and also, setting the load balancing ratios evenly to the servers to be load balanced.

6. A load balancer setting method executed, in a computer which is connected to a plurality of servers each including a virtual machine environment in which a host operating system that is capable of loading therein a software load balancer for distributively transmitting a processing request to a plurality of transmission targets in response to an instruction, and directly performs communications with another server using a virtual network; and a guest operating system that is started up for executing a service program of processing a customer's service and performs communications with said another server only via the host operating system, are operable as virtual operating systems, the method comprising:
when a load balancer setting instruction in which at least a transmission source service program for transmitting a processing request to be load-balanced is designated, is received, determining a server, in which the guest operating system for executing the transmission source service program operates, as a setting objective server of the software load balancer, and also, determining a server in which the guest operating system for executing a transmission target service program of the processing request transmitted from the transmission source service program operates, as a load balancing objective server;
transmitting an instruction to the setting objective server to load the software load balancer into the host operating system thereof; and
transmitting an instruction to the setting objective server to set at least the load balancing objective server in the software load balancer, as information to be used for the load balancing of transmission data from the transmission source service program.

7. A load balancer setting apparatus connected to a plurality of servers each including a virtual machine environment in which a host operating system that is capable of loading therein a software load balancer for distributively transmitting a processing request to a plurality of transmission targets in response to an instruction, and directly performs communications with another server using a virtual network; and a guest operating system that is started up for executing a service program of processing a customer's service and performs communications with the other server only via the host operating system, are operable as virtual operating systems, the apparatus comprising:
determining means for, when a load balancer setting instruction in which at least a transmission source service program for transmitting a processing request to be load-balanced is designated, is received, determining a server, in which the guest operating system for executing the transmission source service program operates, as a setting objective server of the software load balancer, and also, determining a server, in which the guest operating system operates for executing a transmission target service program of the processing request transmitted from the transmission source service program operates, as a load balancing objective server;
first instruction transmitting means for transmitting an instruction to the setting objective server to load the software load balancer into the host operating system thereof; and
second instruction transmitting means for transmitting an instruction to the setting objective server to set at least the load balancing objective server in the software load balancer, as information to be used for the load balancing of transmission data from the transmission source service program.
